(19) United States
(12) Patent Application Publication
(10) Pub. No.: US 2005/0130633 A1
(43) Pub. Date: Jun. 16, 2005

(54) Methods, systems and computer program products for controlling usage of a mobile terminal

(76) Inventors: Lee Hill, Raleigh, NC (US); Debra Stephens, Cary, NC (US)

Correspondence Address: Myers Bigel Sibley & Sajovec, Post Office Box 37428, Raleigh, NC, 27627, US

(21) Appl. No.: 10/736,079

(22) Filed: Dec. 15, 2003

(51) Int. Cl. H04Q 7/20

(52) U.S. Cl. 455/414.1

(57) ABSTRACT

Methods for controlling usage of a mobile terminal are provided. A usage specification including an identification of allowed numbers, an identification of restricted numbers, a usage time limitation, an expiration value and/or a specification of enabled services of the mobile terminal that are restricted is received. Usage of the mobile terminal is limited based on the received usage specification responsive to receipt of a valid authorization code. The authorization code and/or the usage specification may be received from a keypad and/or input screen of the mobile terminal. Alternatively, the authorization code and/or the usage specification are received from a remote user over a wireless communication connection.

### BACKGROUND OF THE INVENTION

The present invention relates to the field of communications in general and more particularly, to usage of mobile terminals for communications.

Wireless communication systems (networks) are commonly employed to provide voice and data communications to subscribers. For example, analog cellular radiotelephone systems, such as those designated AMPS, ETACS, NMT-450, and NMT-900, have long been deployed successfully throughout the world. Digital cellular radiotelephone systems such as those conforming to the North American standard IS-54 and the European standard GSM have been in service since the early 1990's. More recently, a wide variety of wireless digital services broadly labeled as PCS (Personal Communications Services) have been introduced, including advanced digital cellular systems conforming to standards such as IS-136 and IS-95, lower-power systems such as DECT (Digital Enhanced Cordless Telephone) and data communications services such as CDPD (Cellular Digital Packet Data). These and other systems are described in The Mobile Communications Handbook, edited by Gibson and published by CRC Press (1996).

FIG. 1 illustrates a conventional terrestrial mobile (wireless) telecommunications network 20 that may implement any one of a variety of known wireless communications standards including uplink and downlink signals. The wireless network may include one or more wireless mobile terminals 22 that communicate with a plurality of cells 24 served by base stations 26 and a mobile telephone switching office (MTSO) 28. Although only three cells 24 are shown in FIG. 1, a typical cellular radiotelephone network may comprise hundreds of cells, and may include more than one MTSO 28 and may serve thousands of wireless mobile stations 22.

The cells 24 generally serve as nodes in the network 20, from which links (connections) are established between wireless mobile terminals 22 and a MTSO 28, by way of the base stations 26 servicing the cells 24. Each cell 24 will have allocated to it one or more dedicated control channels and one or more traffic channels. The control channel is a dedicated channel that may be used for downlink transmission (network to mobile) of cell identification and paging information. The traffic channels carry the voice and data information. Through the network 20, a duplex (downlink and uplink) radio communication connection 30 may be effected between two wireless mobile stations 22 or between a wireless mobile station 22 and a landline telephone user 32 via a public switched telephone network (PSTN) 34. The function of the base station 26 is commonly to handle the radio communications between the cell 24 and the wireless mobile station 22. In this capacity, the base station 26 functions chiefly as a relay station for data and voice signals. It is also know to provide mobile telecommunications networks in which the base stations are satellites, having associated coverage areas, rather than terrestrial base stations.

The mobile terminals 22 may operate to provide communication services related to voice telecommunications in addition to other services, such as internet access, email, messaging and the like. Such services are often provided by the telecommunications network 20 on a usage based pricing plan. For example, airtime charges, long distance charges, differential charges for particular services, differential charges for access to a network remote from the home provider (roaming) charges and the like may be associated with usage of a mobile terminal 22. Accordingly, undesirable costs can be incurred from unauthorized usage of the mobile terminals 22, which are typically portable devices that may be readily lost or misplaced. Therefore, it is known to provide a lockout feature on such mobile terminals. Typically, the mobile terminal 22 includes a menu option accessible to a user allowing the user to enter a security lockout code. After entry of the code and activation of the security feature, the security code has to be entered before a user is allowed access to the services offered by the mobile terminal 22. As a result, an individual coming upon a lost or misplaced mobile terminal 22 may be prevented from making use of the services provided by the mobile terminal 22 at the expense of the owner.

Another approach to controlling the risks of economic loss caused by lost or misplaced mobile terminals 22 is provision of prepaid mobile terminals. Such devices include a time limit on the services provided by the mobile terminal 22 at the time purchased. As a result, even if the mobile terminal is misplaced, the exposure to loss for the owner is limited to the total dollar value of the time authorized for the mobile terminal. Another security feature available for mobile terminals where service providers provide access to airtime with associated charges both for placed and received calls is to provide call blocking to limit usage of the cell phone to receive calls.

### SUMMARY OF THE INVENTION

Embodiments of the present invention include methods for controlling usage of a mobile terminal. A usage specification including an identification of allowed numbers, an identification of restricted numbers, a usage time limitation, an expiration value and/or a specification of enabled services of the mobile terminal that are restricted is received. It will be understood that the listing of possible limitations included in a usage specification according to the present invention and the term “and/or” as used herein refers to and encompasses any and all possible combinations of one or more of the limitations. Usage of the mobile terminal is limited based on the received usage specification responsive to receipt of a valid authorization code. The authorization code and/or the usage specification may be received from a keypad and/or input screen of the mobile terminal. Alternatively, the authorization code and/or the usage specification are received from a remote user over a wireless communication connection.

In some embodiments of the present invention, the authorization code is received from a remote user over a wireless communication connection and the authorization code is encoded to restrict viewing of the authorization code by a user of the mobile terminal. The authorization code may be a reset code and the method may include over-riding the usage specification responsive to receipt of the reset code. Over-riding the usage specification may include selecting an alternate usage specification responsive to receipt of the reset code. The alternate usage specification may include no restrictions to return the mobile terminal to a normal operating mode.

In other embodiments of the present invention, receiving a usage specification includes accessing a usage controls menu of the mobile terminal. A user is prompted for entry of the authorization code and the authorization code is verfied. A menu of usage restriction options is provided to a user only if the authorization code is verified as valid. A selection of restrictions is received from the user responsive to the provided menu and the usage specification is generated responsive to the received selection of restrictions.

In further embodiments of the present invention, receiving a selection of restrictions includes receiving a disable request and generating the usage specification includes generating a usage specification that includes no restrictions to place the mobile terminal in a normal operating mode. Receiving a selection of restrictions may include receiving an identification of allowed numbers. In some embodiments, providing a menu includes providing a listing of numbers from a phone book of the mobile terminal to a display of the mobile terminal and receiving a designation of ones of the displayed listing of numbers. The selection of restrictions may include an identification of restricted numbers and/or a specification of enabled services of the mobile terminal that are restricted.

The specification of enabled services may include a restriction on internet access services of the mobile terminal. The specification of enabled services may include a restriction on placement of long distance calls and/or calls to specified area codes from the mobile terminal. The specification of enabled services also may include a restriction on placement of calls to specified area codes, such as a designation of allowed area codes for calls from the mobile terminal. In other embodiments of the present invention, receiving a selection of restrictions includes receiving a restriction on placement of calls when the mobile terminal is in a roaming mode.

In other embodiments of the present invention, limiting usage of the mobile terminal includes allowing placement of emergency calls even if usage of the mobile terminal is otherwise restricted. Placement of calls to a specified number may also be allowed even if usage of the mobile terminal is otherwise restricted. The usage time limitation may include a limitation on times of day when the mobile terminal may be used and/or a limitation on the duration of usage of the mobile terminal.

In further embodiments of the present invention, usage control systems for a mobile terminal are provided. A usage control system includes a user interface circuit for receiving from a user an authorization code and a usage specification including an identification of allowed numbers, an identification of restricted numbers, a usage time limitation, an expiration value and/or a specification of enabled services of the mobile terminal that are restricted. The system further includes an access circuit configured to limit usage of the mobile terminal based on the received usage specification responsive to receipt of a valid authorization code. Mobile terminals including the usage control system are also provided.

In other embodiments of the present invention, the user interface includes a keypad and/or input screen of the mobile terminal. The user interface in other embodiments includes a transceiver configured to receive the authorization code and/or the usage specification from a remote user over a wireless communication connection. The user interface may be configured to restrict viewing of the authorization code by a user of the mobile terminal.

In further embodiments of the present invention, the authorization code is a reset code and the access circuit is further configured to over-ride the usage specification responsive to receipt of the reset code to return the mobile terminal to a normal operating mode. The user interface may include a usage controls menu of the mobile terminal and a menu of usage restriction options. The system may further include a memory including an identification of a valid authorization code and usage restriction options. The user interface may be configured to retrieve a listing of numbers from a phone book of the mobile terminal and to display the listing of numbers on a screen of the mobile terminal responsive to selection of an associated option on the menu of usage restriction options and to receive a designation of ones of the displayed listing of numbers to include in the usage specification.

Computer program products for controlling usage of a mobile terminal are also provided.

### BRIEF DESCRIPTION OF THE DRAWINGS

FIG. 1 is a schematic block diagram illustrating a conventional terrestrial wireless communication system;

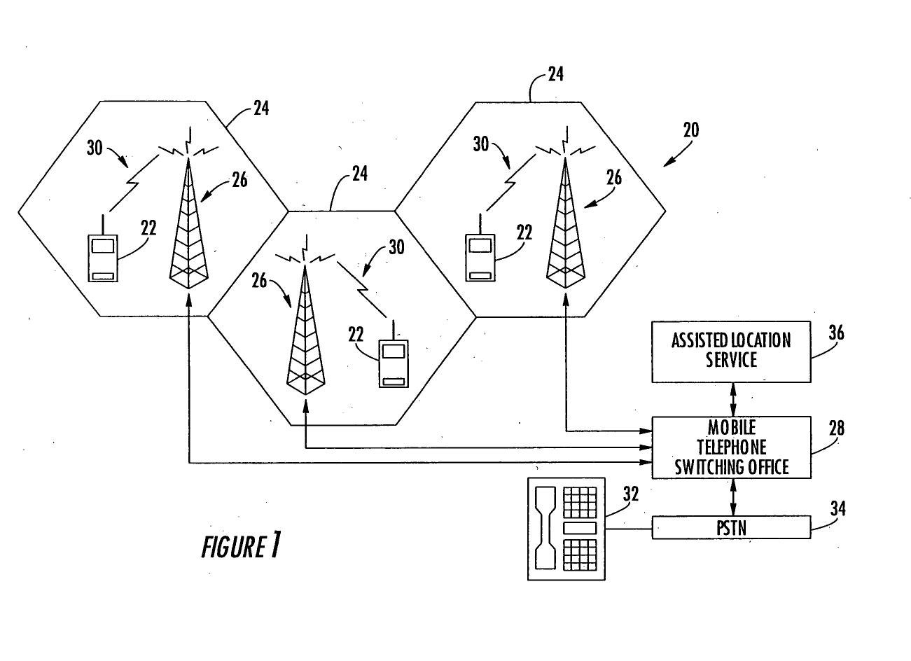

FIG. 2 is a schematic block diagram illustrating a mobile terminal including a system for controlling usage of the mobile terminal according some to embodiments of the present invention;

FIG. 3 is a flow chart illustrating operations for controlling usage of a mobile terminal according to some embodiments of the present invention;

FIG. 4 is a flow chart illustrating operations for controlling usage of a mobile terminal according to further embodiments of the present invention; and

FIG. 5 is a flow chart illustrating operations for limiting usage of a mobile terminal when a service request is received according to some embodiments of the present invention.

### DETAILED DESCRIPTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As will be appreciated by one of skill in the art, the present invention may be embodied as a method, system, mobile terminal or computer program product. Accordingly, the present invention may take the form of an entirely hardware embodiment, an entirely software embodiment or an embodiment combining software and hardware aspects, all generally referred to herein as a “circuit.”

Computer program code for carrying out operations of the present invention may be written in an object oriented programming language such as Java®, Smalltalk or C++, a conventional procedural programming languages, such as the “C” programming language, or lower-level code, such as assembly language and/or microcode. The program code may execute entirely on a single processor and/or across multiple processors, as a stand-alone software package or as part of another software package.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart illustration and/or block diagram block or blocks.

The computer program instructions may also be loaded onto a computer or other programmable data processor to cause a series of operational steps to be performed on the computer or other programmable processor to produce a computer implemented process such that the instructions that execute on the computer or other programmable processor provide steps for implementing the functions or acts specified in the flowchart illustration and/or block diagram block or blocks.

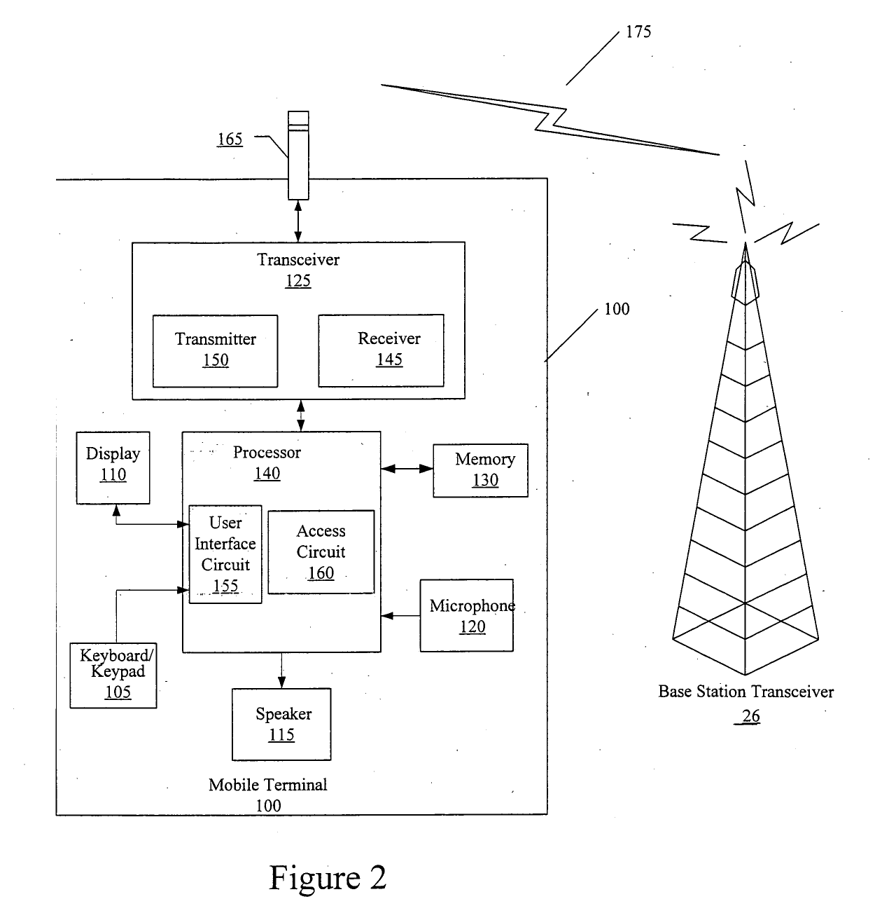

Embodiments of the present invention will now be further described with reference to the schematic block diagram illustration of a mobile terminal 100 in FIG. 2. FIG. 2 illustrates a mobile wireless terminal 100 receiving a wireless communication network signal 175. The mobile terminal 100 may include a keyboard/keypad 105, a display 110, a speaker 115, a microphone 120, a network transceiver 125, and a memory 130 that communicate with a processor 140. The network transceiver 125 typically comprises a transmitter circuit 150 and a receiver circuit 145, which respectively transmit outgoing radio frequency signals to a base station 26 of the wireless communication network and receive incoming radio frequency signals from the base station 26 via an antenna 165. While a single antenna 165 is shown in FIG. 2, it is to be understood that multiple antennas and/or different types of antennas may be utilized based on the types of signals being received. The radio frequency signals transmitted between the mobile terminal 100 and the base station 26 may comprise both traffic and control signals (e.g., paging signals/messages for incoming calls), which are used to establish and maintain communication with another party or destination, and may provide uplink and/or downlink communications. However, the present invention is not limited to such two-way communication systems.

With respect to their role in various conventional operations of the mobile terminal 100, the foregoing components of the mobile terminal 100 may be included in many conventional mobile terminals and their functionality is generally known to those skilled in the art. It should be further understood, that, as used herein, the term “mobile terminal” may include a cellular radiotelephone with or without a multi-line display; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; and a conventional laptop and/or palmtop receiver or other device that includes a radiotelephone transceiver. Mobile terminals may also be referred to as “pervasive computing” devices.

Also shown in the mobile terminal 100 of FIG. 2 is a user interface circuit 155 and an access circuit 160 that, as illustrated in FIG. 2, may be implemented in the processor 140. However, it is to be understood that the user interface circuit 155 and the access circuit 160 may also be separate circuits operatively coupled as described herein to various other components of the mobile terminal 100. The user interface circuit 155 is configured to receive, from a user, an authorization code and a usage specification. The usage specification may include one or more restrictions or limitations on the usage of the mobile terminal 100, such as an identification of allowed numbers, an identification of restricted numbers, a usage time limitation, an expiration value for the usage specification and/or a specification of enabled services of the mobile terminal that are restricted, all responsive to receipt of a valid authorization code. The user interface circuit 155 may include or be operatively coupled to various user input/output devices such as the display 110 (which may be a touchscreen supporting both input and output) and the keyboard/keypad 105 to obtain input from a user as well as to prompt a user with information suitable for obtaining the necessary information to define a usage specification for the mobile terminal 100. The access circuit 160 is configured to limit usage of the mobile terminal 100 based on the received usage specification from the user interface circuit 155.

The user interface circuit 155 and the access circuit 160 may thus provide a usage control system for the mobile terminal 100 to limit usage of the mobile terminal 100. For example, an authorized user could specify allowed numbers that could be called (and/or from which calls could be received) by a user of the mobile terminal 100 while the usage specification was active. Further examples include designating restricted numbers not allowed for usage with the mobile terminal 100. In addition, a prepaid phone configuration could be simulated by specifying a maximum time of usage for the mobile terminal 100 while the usage specification is in effect. In addition, various services of the mobile terminal 100 could be restricted such as locking out calls in a roaming mode where additional air access times may apply, locking out internet access, multimedia messaging access, email, camera and/or video functions and the like and restricting or preventing long distance call placement and/or placement of calls to specified area codes (or only allowing access to specified area codes).

Usage control for a mobile terminal according to some embodiments of the present invention may allow a parent or other user to establish limitations on the use of the mobile terminal by other users, thus allowing parental controls on cell phone usage, for example, by children. Similarly a company could control corporate phone usage.

Examples of such usage specifications may vary in different embodiments of the present invention. For example, a father could set a two hour limit on the mobile terminal and give the mobile terminal to a child for their use. Once the child user reaches the maximum amount (2 hours) of airtime consumption, the mobile terminal would become inoperable. An exception could be provided, for example, for emergency (E911) calls and/or other specified always on call numbers that would not be subject to restriction (i.e., specified as available regardless of airtime and/or restrictions included in the usage specification, such as the parents' phone numbers).

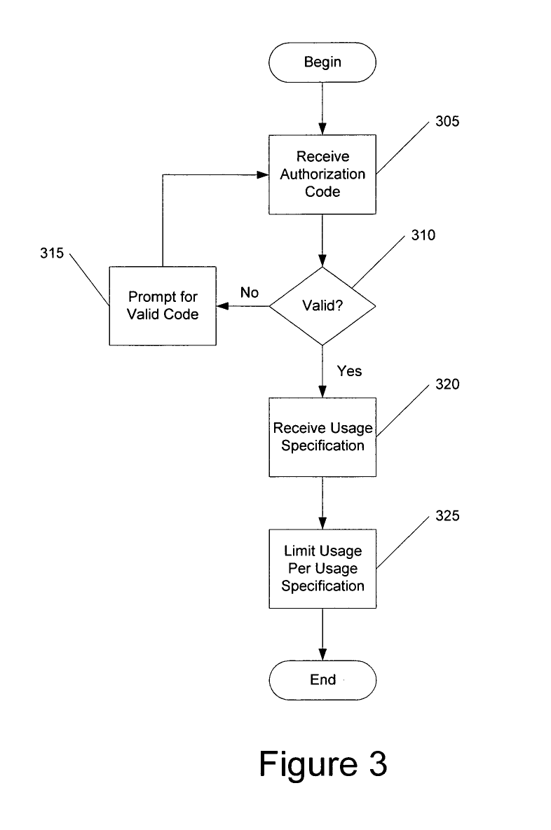

FIGS. 3 through 5 are flowchart illustrations of operations that may be carried out by a mobile terminal 100 according to some embodiments of the present invention. Operations related to controlling usage according to some embodiments of the present invention will now be described with reference to the flow chart diagram of FIG. 3. As shown in FIG. 3, operations begin at Block 305 with receipt of an authorization code by the mobile terminal 100. If the authorization code is valid (Block 310), a usage specification is received, including an identification of allowed numbers, an identification of restricted numbers, a usage time limitation, an expiration value and/or a specification of enabled services of the mobile terminal 100 that are restricted (Block 320). If the received authorization code is not valid (Block 310), the user is prompted for a valid code (Block 315). Usage of the mobile terminal 100 is limited based on the received usage specification if a valid authorization code has been provided (Block 325). It will be understood that while the flowchart of FIG. 3 illustrates that the usage specification is only obtained after a validated authorization code is entered, the usage specification may be received regardless of the validity of the authorization code. Usage limitations will only be applied and/or changed where a valid authorization code is received.

The authorization code and/or usage specification received at Blocks 305 and 320 may be received, for example, from a keypad 105 or input display screen 110 or audible control of the mobile terminal 100. However, in other embodiments of the present invention the authorization code and/or the usage specification may be received from a remote user over a wireless communication connection 175. In other words, a remote user could be allowed to manipulate the usage specification by sending data/signals from a communication device at their location to a controlled mobile terminal 100. Similarly, a remote user could generate the changes through, for example, a website maintained by a wireless service provider. Changes to the usage specification could still be controlled by allowing modification only following entry of a valid authorization code by a remote user rather than allowing uncontrolled modification. Thus, for example, a child who had used up their time allocation under a pre-established usage specification could contact a parent and obtain an additional allocation of time of usage for the mobile terminal 100 without having first to return the mobile terminal 100 to the parent.

The authorization code entered into the mobile terminal at Block 305 may be encoded to restrict viewing of the authorization code by a user of the mobile terminal 100. In some embodiments of the present invention, the authorization code may be a reset code and a currently valid/active/unexpired usage specification may be overridden responsive to receipt of such a reset code. Such embodiments using a reset code may be particularly suited to remote user updating on the restrictions on a mobile terminal 100. In particular embodiments of the present invention, overriding the usage specification may include selecting an alternate usage specification responsive to receipt of the reset code. The alternate usage specification may include no restrictions returning a mobile terminal to a normal operating mode where the usage control system of the present invention does not limit usage of the mobile terminal 100.

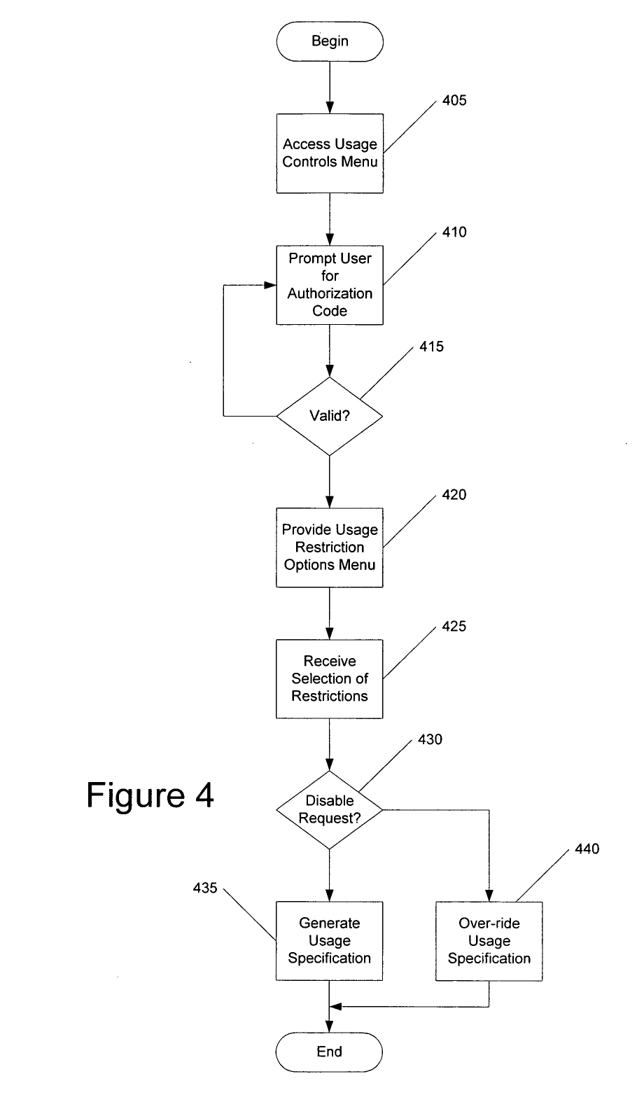

Further embodiments of controlling usage of a mobile terminal according to the present invention will now be described with reference to the flowchart illustration of FIG. 4. FIG. 4 illustrates particular embodiments for receiving a usage specification from an authorized user and generating a usage specification controlling usage of the mobile terminal based on the input usage specification information. As shown in FIG. 4, operations begin at Block 405 by accessing a usage controls menu of the mobile terminal 100. For example, the usage controls menu may be a main menu option or be available under a tool kit, settings, or the like option provided by the operating system of the mobile terminal 100. A user is then prompted for an authorization code (Block 410), for example, by the processor 140 generating display information on the display 110. The authorization code is verified and, if valid, (Block 415), a menu of usage restriction options is provided to a user (Block 420). If the provided authorization code is not valid (Block 415), operations may return to Block 410 to provide the user a further opportunity to enter a valid authorization code. However, it may be desirable to limit the number of opportunities provided to enter a valid authorization code to increase the difficulty of a frequent user, such as a child, from determining the authorization code by trial-and-error.

The usage restriction options menu may include a variety of options, such as identification of allowed call numbers, identification of disallowed call numbers, entry of a usage time limit, entry of an expiration time window for the usage specification, or a specification of an enabled service of a mobile terminal that is to be restricted. The usage time limit may be a time of day related limit, such as no usage during school class hours, or an hour limit on the amount of usage over a specified time period. A selection of one or more of the restrictions is received from the user responsive to the provided usage restriction options menu (Block 425). For example, a parent could first select a usage duration limitation and designate two hours followed by selecting the identification of allowed numbers restriction option and entering numbers that the child user would be allowed to call from the mobile terminal.

One of the available options from the usage restriction options menu, or as provided by a transmitted reset code from a remote location, may be a disable request. In such cases, responsive to receipt of a disable request (Block 430) a previously activated usage specification may be overridden (Block 440). Where the received usage specification is not such a disable request (Block 430), a usage specification is generated responsive to the selection of restrictions received at Block 425 (Block 435). In addition to overriding a usage specification by a disable request, limitations on the use of the mobile terminal 100 may also be removed in various embodiments of the present invention by generating a usage specification containing no limitations to place the mobile terminal in a normal operating mode.

In some embodiments of the present invention, the menu of usage restrictions provided at Block 420 for particular restriction options may be a multi-level menu structure to facilitate user entry of the user specification information. For example, selecting an option allowing identification of allowed and/or restricted numbers may provide the option to the user of selecting the identification of numbers based on a listing of numbers from a phone book of the mobile terminal 100. Such a phone book may be maintained, for example, in the memory 130 (FIG. 2). The listing of numbers from the phone book may be displayed on the display 110 of the mobile terminal 100 and the selection of restrictions received at Block 425 may be received by receiving a designation of ones of the displayed listing of numbers. For example, the keyboard/keypad 105 may include arrow or toggle stick control of a cursor on the display 110 to move to various displayed numbers and select a highlighted number for inclusion in the usage specification.

As discussed previously, the restrictions entered at Block 425 need not be limited to restrictions on placement of calls from the mobile terminal 100 but may also relate to particular services provided by the mobile terminal. For example, the enabled services for the mobile terminal may include internet access services and the received selection of restrictions at Block 425 may disable or restrict usage of such internet services. Similarly, the received selection of restrictions at Block 425 may include a restriction on placement of long distance calls and/or calls to a specified area code from the mobile terminal. Restrictions on roaming and the like may also be supported by providing appropriate options on the usage restriction options menu at Block 420 and receiving corresponding user input at Block 425. As discussed above, exceptions to the various entered restrictions may also be preprogrammed in the mobile terminal 100, such as allowing placement of emergency calls even if one or more other usage restriction would otherwise limit placement of such calls. Similarly, specified numbers, such as a parent's home number, may be maintained as always allowed even without entry of such a number as an allowed number during generation of a usage specification.

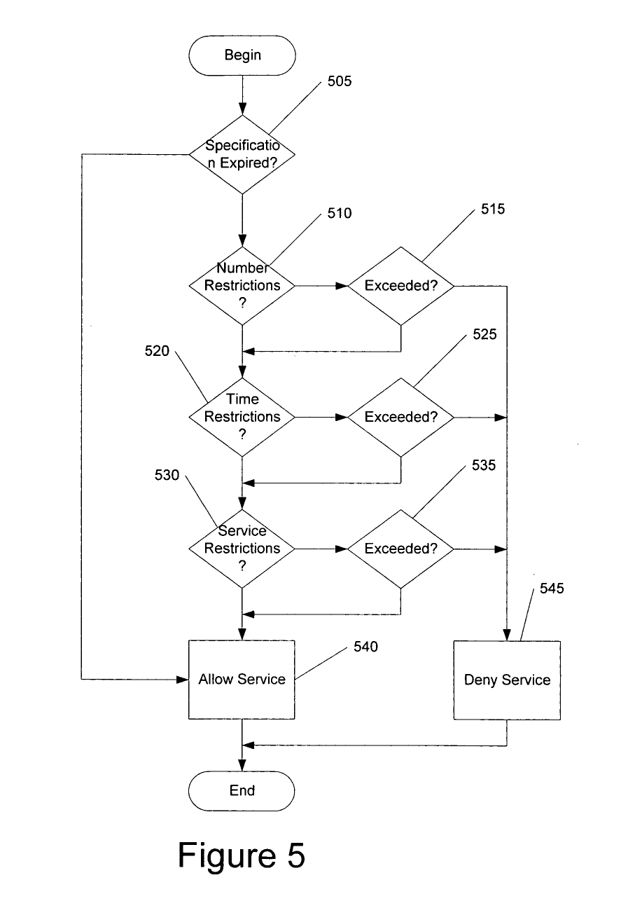

Operations related to limiting usage of the mobile terminal 100 per a usage specification, corresponding to Block 425 of FIG. 3 will now be described for some embodiments of the present invention with reference to the flowchart illustration of FIG. 5. For the operations illustrated in FIG. 5, mobile terminal 100, upon receipt of a request to place or receive a call or other provide some other service from a user of the mobile terminal 100, determines if the currently enabled usage specification has an associated expiration value and whether that specified expiration value has expired (Block 505). If so (Block 505), then service is allowed (Block 540). If the current usage specification is not yet expired (Block 505), then it is determined if any number restrictions (allowed or restricted) have been identified (Block 510). If so, it is determined if the number restrictions would be exceeded (violated) (Block 515). If number restrictions apply and such restrictions would be exceeded or violated by the specific requested service, service is denied (Block 545). In other words, the mobile terminal 100 will not allow the user to place or receive call from the requested (or calling) number. It will further be understood that such number based restrictions may or may not be enabled for a particular mobile terminal 100 regardless of whether the mobile terminal 100 supports caller identification features. However, it will be understood that implementation of restrictions by calling number on the mobile terminal 100 (as opposed to restrictions on outgoing call placement) may require the ability to identify the calling number to implement any such restrictions.

If no number restrictions have triggered denial of service at Block 545 it is determined if any usage time (duration or time of day) limitations are included in the active usage specification (Block 520). If so and if such a usage time limitation would be exceeded/violated (Block 525) then the requested service is denied (Block 545). If there are no active and exceeded time restrictions, it is determined if any enabled services of the mobile terminal have been restricted (Block 530). If there are any such service restrictions and the request would violate or exceed any such restriction (Block 535), the requested service is denied (Block 545). For example, if the user has requested access to the internet services function of the mobile terminal 100 and such usage has been disabled under the usage specification, the user's request to access the internet will be denied at Block 545. If none of the active restrictions of the current usage specification would be violated by the received user request for service, the service is allowed (Block 540).

The flowcharts, flow diagrams and block diagrams of FIGS. 2 through 5 illustrate the architecture, functionality, and operation of possible implementations of systems, methods and computer program products for controlling usage of a mobile terminal according to embodiments of the present invention. In this regard, each block in the flow charts or block diagrams may represent a module, segment, or portion of code, which comprises one or more executable instructions for implementing the specified logical act(s). It should also be noted that, in some alternative implementations, the acts noted in the blocks may occur out of the order noted in the figures. For example, two blocks shown in succession may, in fact, be executed substantially concurrently, or the blocks may sometimes be executed in the reverse order, depending upon the functionality involved.

In the drawings and specification, there have been disclosed typical illustrative embodiments of the invention and, although specific terms are employed, they are used in a generic and descriptive sense only and not for purposes of limitation, the scope of the invention being set forth in the following claims.

1. A method for controlling usage of a mobile terminal, the method comprising:
receiving a usage specification including an identification of allowed numbers, an identification of restricted numbers, a usage time limitation, an expiration value and/or a specification of enabled services of the mobile terminal that are restricted; and
limiting usage of the mobile terminal based on the received usage specification responsive to receipt of a valid authorization code.

2. The method of claim 1 wherein the authorization code and/or the usage specification are received from a keypad and/or input screen of the mobile terminal.

3. The method of claim 1 wherein the authorization code and/or the usage specification are received from a remote user over a wireless communication connection.

4. The method of claim 3 wherein the authorization code is received from a remote user over a wireless communication connection and wherein the authorization code is encoded to restrict viewing of the authorization code by a user of the mobile terminal.

5. The method of claim 4 wherein the authorization code is a reset code and wherein the method further comprises over-riding the usage specification responsive to receipt of the reset code.

6. The method of claim 5 wherein over-riding the usage specification comprises selecting an alternative usage specification responsive to receipt of the reset code.

7. The method of claim 6 wherein the alternate usage specification includes no restrictions to return the mobile terminal to a normal operating mode.

8. The method of claim 4 wherein the usage specification is received from a remote user over a wireless communication connection.

9. The method of claim 1 wherein receiving a usage specification comprises:
accessing a usage controls menu of the mobile terminal;
prompting a user for entry of the authorization code;
verifying the authorization code;
providing a menu of usage restriction options to a user only if the authorization code is verified as valid;
receiving a selection of restrictions from the user responsive to the provided menu; and
generating the usage specification responsive to the received selection of restrictions.

10. The method of claim 9 wherein receiving a selection of restrictions comprises receiving a disable request and wherein generating the usage specification comprises generating a usage specification that includes no restrictions to place the mobile terminal in a normal operating mode.

11. The method of claim 9 wherein receiving a selection of restrictions comprises receiving an identification of allowed numbers.

12. The method of claim 11 wherein providing a menu includes providing a listing of numbers from a phone book of the mobile terminal to a display of the mobile terminal and wherein receiving a selection of restrictions comprises receiving a designation of ones of the displayed listing of numbers.

13. The method of claim 11 wherein receiving a selection of restrictions comprises receiving an identification of restricted numbers.

14. The method of claim 9 wherein receiving a selection of restrictions comprises receiving a specification of enabled services of the mobile terminal that are restricted and wherein the specification of enabled services includes a restriction on internet access services of the mobile terminal.

15. The method of claim 9 wherein receiving a selection of restrictions comprises receiving a specification of enabled services of the mobile terminal that are restricted and wherein the specification of enabled services includes a restriction on placement of long distance calls and/or calls to specified area codes from the mobile terminal.

16. The method of claim 15 wherein the specification of enabled services includes a restriction on placement of calls to specified area codes and wherein the restriction of placement of calls to specified area codes comprises a designation of allowed area codes for calls from the mobile terminal.

17. The method of claim 9 wherein receiving a selection of restrictions comprises receiving a specification of enabled services of the mobile terminal that are restricted and wherein the specification of enabled services includes a restriction on placement of calls when the mobile terminal is in a roaming mode.

18. The method of claim 1 wherein limiting usage of the mobile terminal further comprises allowing placement of emergency calls even if usage of the mobile terminal is otherwise restricted.

19. The method of claim 1 wherein limiting usage of the mobile terminal further comprises allowing placement of calls to a specified number even if usage of the mobile terminal is otherwise restricted.

20. The method of claim 1 wherein the usage time limitation includes a limitation on times of day when the mobile terminal may be used.

21. The method of claim 1 wherein the usage time limitation includes a limitation on the duration of usage of the mobile terminal.

22. A usage control system for a mobile terminal, the system comprising:
a user interface circuit for receiving from a user an authorization code and a usage specification including an identification of allowed numbers, an identification of restricted numbers, a usage time limitation, an expiration value and/or a specification of enabled services of the mobile terminal that are restricted; and
an access circuit configured to limit usage of the mobile terminal based on the received usage specification responsive to receipt of a valid authorization code.

23. A mobile terminal including the usage control system of claim 22.

24. The system of claim 22 wherein the user interface includes a keypad and/or input screen of the mobile terminal.

25. The system of claim 24 wherein the user interface further includes a transceiver configured to receive the authorization code and/or the usage specification from a remote user over a wireless communication connection.

26. The system of claim 25 wherein the user interface is further configured to restrict viewing of the authorization code by a user of the mobile terminal.

27. The system of claim 26 wherein the authorization code is a reset code and wherein the access circuit is further configured to over-ride the usage specification responsive to receipt of the reset code to return the mobile terminal to a normal operating mode.

28. The system of claim 22 wherein the user interface further comprises:
a usage controls menu of the mobile terminal;
a menu of usage restriction options; and
wherein the system further comprises a memory including an identification of a valid authorization code and usage restriction options.

29. The system of claim 28 wherein the user interface is further configured to retrieve a listing of numbers from a phone book of the mobile terminal and to display the listing of numbers on a screen of the mobile terminal responsive to selection of an associated option on the menu of usage restriction options and to receive a designation of ones of the displayed listing of numbers to include in the usage specification.

30. A computer program product for controlling usage of a mobile terminal, the computer program product comprising:
a computer-readable storage medium having computer-readable program code embodied in said medium, said computer-readable program code comprising:
computer-readable program code that receives a usage specification including an identification of allowed numbers, an identification of restricted numbers, a usage time limitation, an expiration value and/or a specification of enabled services of the mobile terminal that are restricted; and
computer-readable program code that limits usage of the mobile terminal based on the received usage specification responsive to receipt of a valid authorization code.
